(19) United States
(12) Patent Application Publication
(10) Pub. No.: US 2009/0230791 A1
(43) Pub. Date: Sep. 17, 2009

(54) DRIVE UNIT HAVING OPTIMIZED COOLING

(75) Inventors: Stephan Scharfenberg, Tüttleben (DE); Roland Altvater, Friedrichshafen (DE); Kai Heinrich, Bodnegg (DE); Markus Nold, Friedrichshafen (DE); Torsten Hering, Überlingen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/067,090

(22) PCT Filed: Sep. 23, 2006
(86) PCT No.: PCT/EP06/09263

§ 371 Date: Mar. 17, 2008

(30) Foreign Application Priority Data
Sep. 29, 2005 (DE) 10 205 046 618.4

(51) Int. Cl. H02K 16/00; H02K 9/06; H02K 7/102; H02K 11/00

(52) U.S. Cl. 310/62; 310/112; 310/77; 310/68 D

(57) ABSTRACT

The invention concerns an electric drive unit with a steering motor and a propulsion motor which are arranged co-axially with one another and which, respectively, steer a wheel of the vehicle or drive it in the sense of propulsive movement. A first motor (1) has a hollow drive shaft (2), through which passes a second drive shaft (3) of the second motor (4). The second drive shaft (3) also extends through an outer wall (5) of the drive unit and, on the outside (6), is connected rotationally fixed to a fan wheel (7), such that air for cooling is blown outside along the housing of the drive unit.

The invention concerns an electric drive unit with at least one steering motor and a drive motor arranged co-axially therewith, according to the preambles of claim 1 and claim 6.

Conveyor trolleys have known drive units in which a wheel of the vehicle is driven by a drive motor and steered by a steering motor.

One such is described in DE 199 49 351 A1, which discloses an electric drive unit for a conveyor trolley in which a drive motor and a steering motor are arranged co-axially and both these electric motors are mounted vertically in the vehicle. A reduction transmission is arranged between the drive motor and the steering motor.

DE 103 28 651 A1 shows an electric drive unit in which, likewise, a drive motor and a steering motor are arranged co-axially and mounted vertically in the vehicle. The drive motor is directly above the steering motor.

In the known drive units, the electronic units of the drives are fixed on the outside of the housing of the drive unit. This allows the heat produced to be dissipated easily. If the electronic units are integrated on or in the drive unit, a reliable heat reduction must be ensured.

The purpose of the present invention is to provide a compactly built drive unit which enables good dissipation of heat.

This objective is achieved with a drive unit having the characteristics of claims 1 and 6.

According to the invention, the objective is achieved by an electric drive unit comprising a steering motor and a drive motor arranged co-axially with one another. The steering motor drives a wheel of the vehicle in a steering movement and the drive motor drives the vehicle wheel in a propulsion movement. The first of the two motors has a hollow drive shaft through which passes a second drive shaft of the second motor. The second drive shaft continues on to project through a first axial outer wall of the drive unit. This axial outer wall is in the axial direction on the side opposite to the drive wheel and separates the entire drive unit from its external surroundings. Outside the said outer wall the second drive shaft is connected in a rotationally fixed manner to a fan impeller. The fan impeller blows air in the radial direction along the first outer wall and enables effective cooling of the drive unit.

In one embodiment, the first outer wall is provided on its outside with cooling fins, along which the air blown by the fan flows. This improves the cooling of the drive unit. Advantageously, the cooling fins extend in a radial direction.

According to a another embodiment, the drive unit has a second outer wall which forms a cooling channel with the first outer wall. The air blown by the fan impeller moves radially outward through this cooling channel. To enable cooling air to access the fan impeller, the second outer wall has an aperture in an axial direction. Advantageously, the second outerwall too has cooling fins. In addition, components of the electronic units of the two drive motors can be attached on the inside and/or outside of the first and/or second outer wall. By positioning the electronic units close to the air-cooled, cooling fins, cooling of the drive unit is improved still further. In one embodiment, cooling fins can even be made integrally with the first and/or second outer wall.

In a further embodiment, on the second outer wall, as viewed in a radial direction, a deflector is provided on the outside, which deflects the air blown in the radial direction so that it flows along the outside of the radial outer wall.

Another embodiment of the drive unit again comprises a steering motor and a drive motor arranged co-axially with one another. The steering motor drives a wheel of the vehicle in a steering movement and the drive motor drives the vehicle wheel in a propulsion movement. A first one of the two motors has a hollow drive shaft through which a second drive shaft of the second motor passes. A second fan impeller is attached to the rotor of the second motor. Advantageously, this fan impeller blows air around the stator of the second motor. For this, a second cooling channel is formed in the radial outer wall, through which the air blown by the second fan impeller is blown, in an axial direction, onto the outside of the second motor.

According to another embodiment, the drive housing is connected by way of an axial bearing to a vehicle frame. The space between the outer ring of the bearing and the vehicle frame is advantageously filled with a heat-conducting material to improve the dissipation of heat from the housing of the drive unit by heat conduction into the vehicle frame.

In a further embodiment, the outer ring of the bearing is designed to promote high heat conduction. The inner ring of the bearing is formed so that the bearing has a specified service life. In the design of the outer ring, the heat transfer by conduction, between the housing of the drive unit and the outer ring and between the outer ring and the vehicle frame, is also taken into account. The larger the two contact surfaces are the more heat can be transferred by conduction. The size of the contact surfaces depends on the radial overlap and thus on the radial width of the outer ring.

In one embodiment, a vehicle brake is arranged between the second motor and the first axial outer wall. Advantageously, the first motor is the steering motor and the second motor is the propulsion motor.

According to a further embodiment, another electronic control unit is arranged under the first motor and is directly connected to the first motor.

To explain the invention and its embodiments more clearly the description of a drawing is given below. The drawing shows:

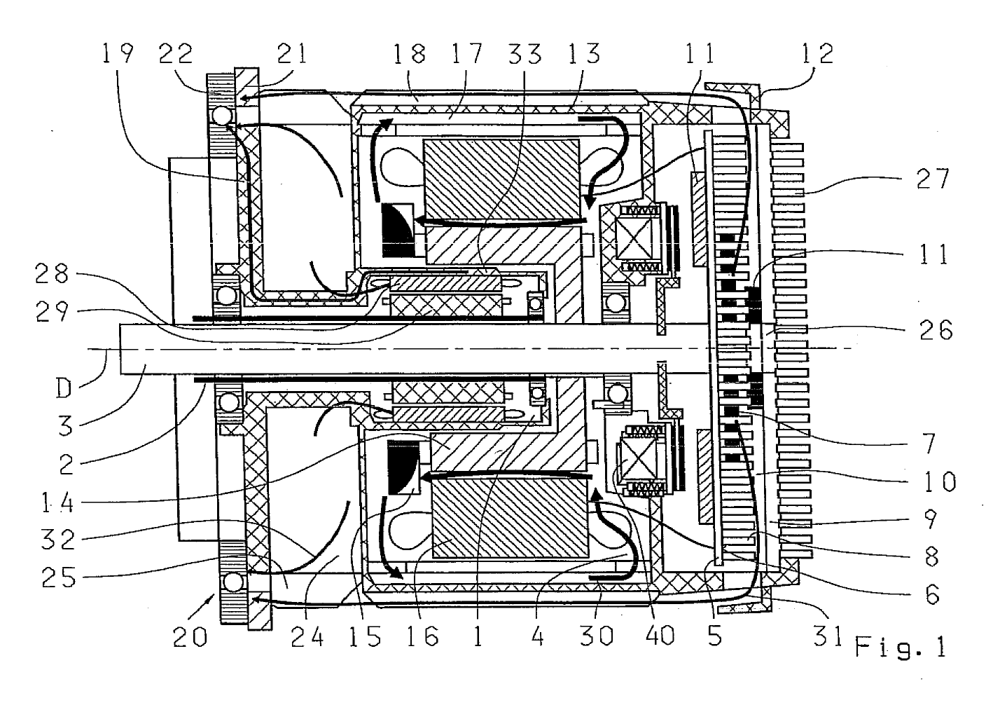

FIG. 1 is a structure of a drive unit, and

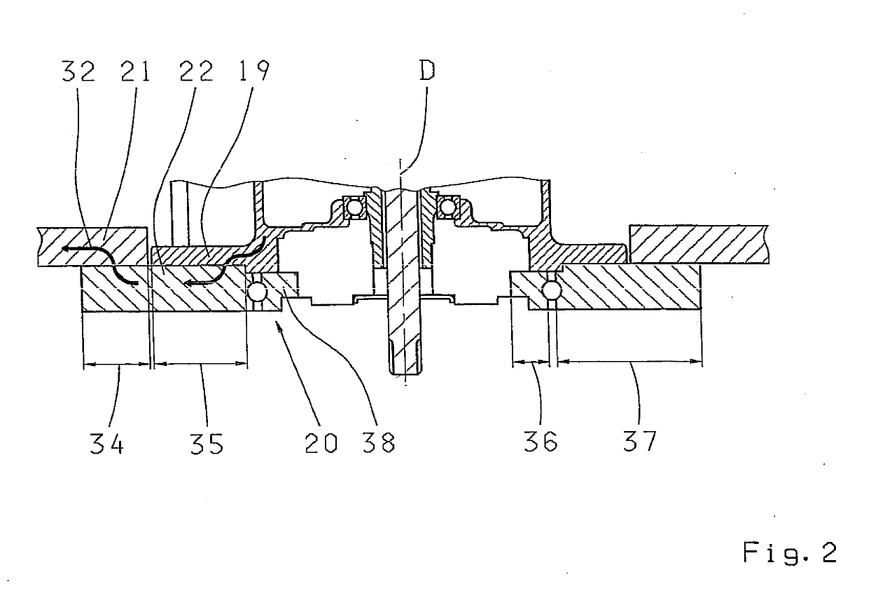

FIG. 2 is a mounting of the drive unit in the vehicle frame

FIG. 1 shows an electric drive unit with a steering motor 1 and a drive motor 4 arranged co-axially with one another and having respective stators 28, 16 and rotors 29, 14. The drive unit has a rotation axis D. A first drive shaft 2 is made hollow. Through the first drive shaft 2 passes a second drive shaft 3. The second drive shaft 3 also extends through a braking device 26 and through a first axial outer wall 5 and on its outer side 6 is connected rotationally fixed to a fan impeller 7. The braking device is located in the axial direction between the propulsion motor 4 and the first outer wall 5. Components of an electronic unit 11 are attached directly on the first outer wall 5. A second axial outer wall 9 is arranged so that together with the first outer wall 5, it forms a cooling channel 10. Cooling fins 8, 27 extending radially, are attached on the two outer walls 5, 9. Also attached on the second axial outer wall 9 are components 11 of the electronic unit. The components 11 of the electronic unit may be for example an electronic power circuit and/or an electronic signal circuit of the drive motor 4 and/or an electronic signal circuit of the steering motor 1. The electronic unit also is made integrally with one of the two outer walls 5, 9. When the drive motor 4 is rotating, the fan impeller 7 is driven so as to blow air in a radial direction through the cooling channel 10. To enable the fan impeller 7 to blow air, the second outer wall 9 has an axial aperture 26. Particularly effective cooling is enabled by the arrangement of the components 11 of an electronic unit on the first and second outer walls 5, 9.

Onto the second outer wall 9 is attached a deflector 12. Thanks to this deflector 12, the air blown in a radial direction is deflected so that, after deflection, it flows in an axial direction along a housing 19 of the drive unit. A radially outer wall 13 is also provided with further cooling fins 18 arranged axially. An electronic unit 24 is fixed directly under the two motors 1, 4, nested one inside the other, and is also provided with cooling fins 25 on its radially outer side. The electronic unit 24 contains at least part of the electronic circuitry for the steering motor 1. The housing 19 of the drive unit is mounted in a vehicle frame 21, via a bearing 20.

On its lower side, the rotor 14 of the propulsion motor 4 is provided with a second fan impeller 15. This second fan impeller 15 blows the air in the inside space of the housing of the drive motor 4 so that it flows around the stator 16. For this, a cooling channel 17 is formed in the radially outer wall 13, through which the blown air can flow in an axial direction over the propulsion motor 4.

To clarify the invention, the direction 30, 31 of air flow blown by the fan impellers 7, 15 are shown in the drawing. A direction 32 of the improved heat transfer out of the housing 19 of the drive unit is also indicated. It can also be seen that the electronic unit 24 and the steering motor 1 are thermally decoupled. Furthermore, the thickness of an outer wall 33 of the steering motor is increased so as to improve heat conduction.

FIG. 2 shows a mounting of the housing 19 of the drive unit in a vehicle frame 21. A radial width 36 of an inner ring 39 is designed at least so that the bearing 20 reaches a specified lifetime and is substantially smaller than a radial width 37 of an outer ring. The housing 19 rests on the outer ring 22 of the bearing 20 and is advantageously connected in a rotationally fixed manner thereto by a screw joint.

The radial width 37 of the outer ring 22 is wider than necessary for the attainment of the aforesaid service life. This allows large radial overlaps 35, 34 to be formed between the housing 19 and the outer ring 22 and between the outer ring 22 and the vehicle frame 21. The large contact areas, between the housing 19, the outer ring 22 and the vehicle frame 21, ensure high heat conduction. The radial width 37 of the outer ring 22 is chosen such that the bearing 20 does not exceed a certain first temperature level. This first temperature level is the temperature at which the lubricant of the bearing 20 would be degraded and perhaps leak out of the bearing 20. As a further design feature the radial width 37 is designed so that the first motor 1, with its associated electronic unit 24, do not exceed a specified second temperature level. Advantageously as a further embodiment, the higher of the two temperature levels is taken into account for the design of the outer ring 22. The radial width 37 of the outer ring 22 is substantially larger than the radial width 36 of the inner ring 38. Advantageously, the radial width 37 of the outer ring 20 is more than twice as large as the radial width 36 of the inner ring 38.

### REFERENCE NUMERALS

1 first motor
2 first drive shaft
3 second drive shaft
4 second motor
5 first axial outer wall
6 outer side
7 first fan impeller
8 cooling fins
9 second axial outer wall
10 first cooling channel
11 components of an electronic unit
12 deflector
13 radially outer wall
14 rotor
15 fan impeller
16 stator
17 second cooling channel
18 cooling fins
19 housing
20 bearing
21 vehicle frame
22 outer ring of the bearing
23 heat-conducting material
24 electronic unit
25 cooling fins
26 aperture
27 cooling fins
28 stator
29 rotor
30 flow direction
31 flow direction
32 flow direction
33 outer wall
34 radial overlap
35 radial overlap
36 radial width
37 radial width
38 inner ring
D rotation axis

1-14. (canceled)

15. An electric drive unit with a steering motor and a propulsion motor, which are arranged co-axially with one another and which, respectively, steer a vehicle wheel and drive the vehicle wheel in the sense of a propulsion movement, a first motor (1) having a hollow drive shaft (2) through which a second drive shaft (3) of the second motor (4) passes, the second drive shaft (3) extending through a first axial outer wall (5) of the electric drive unit and being connected in a rotationally fixed manner to a fan impeller (7) on an outer side (6) of the first axial outer wall (5).

16. The drive unit according to claim 15, wherein the first outer wall (5) and a second axial outer wall (9) form a cooling channel (10) through which air flows radially outwards through several openings.

17. The drive unit according to claim 16, wherein components (11) of an electronic control unit are fixed on at least one of the first axial outer wall (5) and the second axial outer wall (9).

18. The drive unit according to claim 16, wherein cooling fins (8, 27) are fixed on at least one of the outer side (6) of the first axial outer wall (5) and the second axial outer wall (9).

19. The drive unit according to claim 17, wherein cooling fins (27) and a deflector (12) are attached on the second axial outer wall (9), the deflector (12) deflecting the air blown radially outward such that the airflows in an axial direction over a radially outer wall (13) of the drive unit.

20. An electric drive unit with a steering motor and a propulsion motor, which are co-axially arranged, respectively, steer a vehicle wheel and drive the vehicle wheel in the sense of a propulsion movement, a first motor (1) having a hollow drive shaft (2) through which a second drive shaft (3) of a second motor (4) passes, and a second fan impeller (15) being attached on at least one axial end of a rotor (14) of the second motor (4) which blows air inside the second motor (4) such that the flows around a stator (16).

21. The drive unit according to claim 20, wherein at least one cooling channel (17) is formed in a radially outerwall (13) and the air blown by the second fan impeller (15) flows through the at least one cooling channel (17) axially along the second motor (4).

22. The drive unit according to claim 15, wherein cooling fins (18, 25) are attached to at least one of the radially outer wall (13) of the drive unit and an electronic unit (24) of the first motor (1).

23. The drive unit according to claim 15, wherein a housing (19) of the drive unit is connected to a vehicle frame (21) by an axial bearing (20) and an outer ring (22) of the axial bearing (20) is connected to the vehicle frame (21) by a heat-conducting material (23).

24. The drive unit according to claim 23, wherein a radial width (37) of the outer ring (22) is substantially larger than a radial width (36) of an inner ring (38), for improved heat transfer.

25. The drive unit according to claim 24, wherein the radial width (37) of the outer ring (22) is at least twice as large as the radial width (36) of the inner ring (38).

26. The drive unit according to claim 23, wherein a radial overlap (34, 35) between the housing (19) of the drive unit and the outer ring (22) of the bearing (20) and a radial overlap the vehicle frame (21) and the outer ring (22) of the bearing (20) are wide enough for sufficient heat to be dissipated by heat conduction and ensure that at least one of a first temperature level and a second temperature level are not exceeded.

27. The drive unit according to claim 15, wherein a vehicle brake (26) is arranged between the second motor (4) and the first axial outer wall (5).

28. The drive unit according to claim 15, wherein an electronic control unit (24) is arranged close to and underneath the first motor (1) and is connected directly to the first motor (1).

29. An assembly for cooling a drive unit comprising:
a first electric motor (1) having a first stator (28) and a first rotor (29) which is rotationally fixed to a hollow first drive shaft (3);
a second electric motor (4) is co-axially aligned with the first electric motor (1) within a drive unit housing (13) and having a second stator (16) and a second rotor (14) which is rotationally fixed to a second drive shaft (2),
one end of the second drive shaft (2) axially extending at least partially through the first drive shaft (3) and a second end of the second drive shaft (2) passing through a first axial end wall (5);
a first fan impeller (7) being fixed to the second end of the second drive shaft (2) on an axial side of the first axial end wall (5) opposite the second electric motor (4) and directing a flow of air past cooling fins fixed to an exterior of the drive unit housing (13); and
a second fan impeller (15) being fixed to the second rotor (14) and directing air flow inside the drive unit housing (13).
